(19) United States
(12) Patent Application Publication
(10) Pub. No.: US 2021/0174276 A1
(43) Pub. Date: Jun. 10, 2021

(54) INFORMATION PROCESSING APPARATUS, INFORMATION PROCESSING METHOD AND NON-TRANSITORY RECORDING MEDIUM

(71) Applicant: NEC Corporation, Minato-ku, Tokyo (JP)

(72) Inventors: Mineto SATOH, Tokyo (JP); Soichiro ARAKI, Tokyo (JP); Kenichiro FUJIYAMA, Tokyo (JP); Tan AZUMA, Tokyo (JP); Tetsuri ARIYAMA, Tokyo (JP)

(73) Assignee: NEC Corporation, Minato-ku, Tokyo (JP)

(21) Appl. No.: 16/475,485

(22) PCT Filed: Dec. 27, 2017
(86) PCT No.: PCT/JP2017/046823

§ 371 Date: Jul. 2, 2019

(30) Foreign Application Priority Data
Jan. 11, 2017 (JP) 2017-002453

(51) Int. Cl. G06Q 10/06; G06K 9/62; G06F 16/9035

(52) U.S. Cl. CPC G06Q 10/0635; G06F 16/9035; G06K 9/6277

(57) ABSTRACT

The information processing device estimates one of event and factor by giving model information the other; generates association information, the model information representing relevance between an event that occurs on a target and the factor that occurs before the event, the association information associating first event information that represents the event obtained as the estimation result with first factor information that represents the given factor or associating second event information that represents the given event with second factor information that represents the factor obtained as the estimation result; and specifies the factor of third event information representing an event occurred on the target based on the model information by using the third event information and, at least, one of the first event information and the second event information included in the association information.

### TECHNICAL FIELD

The present invention relates to an information processing apparatus that offers estimation information of a target system at low risk.

### BACKGROUND ART

A decision making support technique (or a technique for performing optimum control) for supporting (for example, controlling and giving advice on) decision making in such a way as to bring a target system close to achieve a certain target value or a desirable state is growing in importance. For example, it is greatly worthwhile on the earth and in a social environment that are changing to control a state, in four regions indicated below, to have a low risk that may occur (or have high robustness) and then to maintain the state.
A primary industry such as agriculture of growth on bare ground and fisheries having high uncertainty due to a natural influence,
resources such as water, fossil fuel, or natural energy, and weather (climate),
medical care and health care having high uncertainty due to a biological influence or an influence of an individual difference, and
a traffic system or a distribution system having high uncertainty due to an influence of a human operation.

In a case of decision making on a target system having high uncertainty, it is useful to virtually simulate the target system by a computer. The simulation is a technique for numerically predicting an event by a computer in accordance with model information that is description of the event that occurs in a target system and a hypothetical event for the target system by using mathematical model information. A state in the past, future, and the like or a state in a different space can be simulated for the target system by using a model information. The simulation can achieve decision making support information that performs processing of predicting an event that may occur in the future on a phenomenon and a problem that are difficult to realistically test (for example, that cannot be redone or require a high cost for a test). The processing of predicting an event that may occur in the future may be processing of controlling the state to be brought close to a desirable state, processing of controlling an index related to the state to be brought close to a predetermined target value, or the like. For example, various states from a desirable state to an undesirable state can be simulated for a certain target system by changing an initial condition input to the simulation. Therefore, the simulation can achieve an examination for a characteristic of the target system and a behavior of an event that occurs in the target system without affecting reality.

However, when an error (or gap) occurs between an actual target system and model information representing an event that occurs in the target system, an event predicted by a simulation based on the model information diverges from an actual event occurred in the target system. In this case, the simulation cannot accurately predict a state of the target system and the like, and thus prediction by the simulation has low accuracy. Furthermore, the prediction result may lead to false decision making.

For example, since the above-described four regions are regions having high uncertainty or compound regions having a wide variety, model information generated for a target system in the regions is often generated after simplifying a complicated event that occurs in regard to the target system. Alternatively, in view of a restriction related to calculation time required for a simulation based on the model information, the model information is often generated by approximately representing an event that occurs for the target system. As a result, prediction accuracy of the simulation based on the model information is often dependent to the extent that a person generating the model information accurately understands an event that occurs in a target system and can faithfully express the understood event. Therefore, model information having high prediction accuracy needs to be generated in view of the uncertainty as described above.

In addition to the uncertainty of model information, the uncertainty includes, for example, uncertainty of data input to the model information, and the like. An input to model information, verification of an event predicted based on the model information, calibration of a simulation using the model information, or the like may be performed, based on observation data (observation value) observed for an event that occurs in a target system, for example. However, the observation data may include an environment in which an event is observed and an error of an observation apparatus that observes an event and the like. In other words, in this case, the observation data are data including uncertainty.

A relationship between a period (hereinafter represented as a “data acquisition period”) of acquiring (or observing, measuring) observation data related to a target system and a period of controlling an input in such a way that a state of the target system becomes a desirable state is important. Alternatively, a relationship between the data acquisition period and a period of handling (controlling in the target system) based on a simulation result is important. For example, a proportional-integral-differential controller is one example of a control technique. The PID controller is control of feeding back an input to a target system at a predetermined time, based on a deviation from a target value related to the target system, an integral of the deviation, or a differentiation of the deviation, since observation data of the target system have started to be acquired in real time. In this case, the data acquisition period and a period related to prediction and control processing need to be time of a close order. When this condition is not satisfied, it is difficult to appropriately control the target system.

Further, model predictive control (MPC) represents a procedure for generating model information related to a target system (that is, modeling a target system) in accordance with an inductive technique such as machine learning, based on observation data observed in regard to the target system in real time. Alternatively, the MPC represents a procedure for identifying known model information and then estimating an estimated value based on the identified model information. Furthermore, the MPC represents a procedure for determining an input to a target system based on a relationship between the identified model information and a target value. In this case, sufficient data or a period of acquiring sufficient data is needed for modeling based on observation data and identification of model information. Therefore, a prediction period using model information is dependent on validity of the model information and estimation accuracy based on the model information. Thus, it is difficult to accurately predict an event that occurs in a target system (or appropriately control a target system) over a period longer than a data acquisition period related to the target system.

In contrast, model information for a target system can also be generated, based on off-line data (namely, accumulated past data). In this case, for example, based on data related to a target system acquired off-line, model information representing relevance between an index representing a target value of the target system (or a desirable state of the target system) and an input being one cause of acquisition of the index are generated. Next, support information that performs an appropriate input to a target system or decision making related to the target system, based on an effect estimated in accordance with the generated model information, is provided.

PTL 1 discloses a device that provides support information as described above in a health care region. In the device, input data about a lifestyle of a user and output data about a physiological state that appears in a living body of the user as a result of the lifestyle are previously stored off-line in a storage device. The device estimates relevance between the input data and the output data based on data stored in the storage device. The device generates, based on the estimated relevance, model information for estimating an influence of a lifestyle on a living body. The device estimates a way of improving a life in such a way as to improve a state of a living body, based on the generated model information.

PTL 2 discloses a device that provides support information on a processing device in which a target system is communicatively connected to a communication network. The device estimates a cause event affecting an event that occurs in the processing device, based on an operation state of the processing device and an enormous amount of observation data observed in regard to an environmental state and the like of the processing device. The device provides support information representing a method of handling an event that occurs in the processing device, based on the estimated cause event.

Therefore, the devices disclosed in PTLs 1 and 2 estimate relevance between a factor that occurs in a target system and an event that may be related to the factor, and selects appropriate data from data stored in a database, based on the estimated relevance. The devices provide support information related to the target system by performing such processing. In other words, the devices provide support information by processing data measured in regard to a target in accordance with a functional analysis processing procedure.

### CITATION LIST

### Patent Literature

PTL 1: Japanese Unexamined Patent Application Publication No. 2010-122901

PTL 2: Japanese Unexamined Patent Application Publication No. 2013-255131

### SUMMARY OF INVENTION

### Technical Problem

However, since the device disclosed in PTL 1 estimates relevance between input data and output data, based on inductively generated model information, a certain period (for example, several weeks of data) is needed for the device to calculate accurate relevance. Furthermore, since the device cannot generate accurate relevance for a state of a target system that has not been observed in the past, the device cannot provide support information having a low risk.

Further, since the device disclosed in PTL 2 provides support information, based on observed observation data, a cause event related to an event that has not been observed in the past cannot be accurately estimated. As a result, the device cannot provide support information having a low risk beforehand in regard to support information representing a risk that the event occurs and a method of handling the event. Furthermore, since the device selects an appropriate method of handling from a database in which a method (or knowledge) of handling related to a cause event is stored, the selected method of handling is not always an accurate method of handling.

Thus, one object of the present invention is to provide an information processing apparatus and the like capable of providing estimation information having a low risk.

### Solution to Problem

As an aspect of the present invention, an information processing apparatus includes:

generation means for estimating one of event and factor by giving model information the other, and generating association information, the model information representing relevance between an event that occurs on a target and the factor that occurs before the event, the association information associating first event information that represents the event obtained as the estimation result with first factor information that represents the given factor or associating second event information that represents the given event with second factor information that represents the factor obtained as the estimation result; and

specification means for specifying the factor of third event information representing an event occurred on the target based on the model information by using the third event information and, at least, one of the first event information and the second event information included in the association information.

In addition, as another aspect of the present invention, an information processing method includes:

estimating one of event and factor by giving model information the other, and generating association information, the model information representing relevance between an event that occurs on a target and the factor that occurs before the event, the association information associating first event information that represents the event obtained as the estimation result with first factor information that represents the given factor or associating second event information that represents the given event with second factor information that represents the factor obtained as the estimation result; and

specifying the factor of third event information representing an event occurred on the target based on the model information by using the third event information and, at least, one of the first event information and the second event information included in the association information.

In addition, as another aspect of the present invention, an information processing program includes:

a generation function for estimating one of event and factor by giving model information the other, and generating association information, the model information representing relevance between an event that occurs on a target and the factor that occurs before the event, the association information associating first event information that represents the event obtained as the estimation result with first factor information that represents the given factor or associating second event information that represents the given event with second factor information that represents the factor obtained as the estimation result; and

a specification function for specifying the factor of third event information representing an event occurred on the target based on the model information by using the third event information and, at least, one of the first event information and the second event information included in the association information.

Furthermore, the object is also achieved by a computer-readable recording medium that records the program.

### Advantageous Effects of Invention

The information processing apparatus and the like according to the present invention are able to provide estimation information having a low risk.

### BRIEF DESCRIPTION OF DRAWINGS

FIG. 1 is a block diagram illustrating a configuration of an information processing apparatus according to a first example embodiment of the present invention.

FIG. 2 is a flowchart illustrating a flow of the processing in the information processing apparatus according to the first example embodiment.

FIG. 3A is a diagram representing relevance between an observation value when a prior risk estimation is not performed and a value of a controllable parameter.

FIG. 3B is a diagram representing relevance between an observation value when a prior risk estimation is performed and a value of a controllable parameter.

FIG. 4 is a block diagram illustrating a configuration of an information processing apparatus according to a second example embodiment of the present invention.

FIG. 5 is a flowchart illustrating a flow of the processing in the information processing apparatus according to the second example embodiment.

FIG. 6 is a block diagram illustrating a configuration of an information processing apparatus according to a third example embodiment of the present invention.

FIG. 7 is a flowchart illustrating a flow of the processing in the information processing apparatus according to the third example embodiment.

FIG. 8 is a block diagram schematically illustrating a hardware configuration of a calculation processing apparatus capable of achieving an information processing apparatus according to each example embodiment of the present invention.

### EXAMPLE EMBODIMENT

Firstly, terms used in each example embodiment of the present invention will be described.

It is assumed that a variable or a parameter represents a certain storage region in a storage device (storage unit). Processing of setting data to a variable (or processing of setting a value to a parameter) represents processing of storing data in a storage region identified by the variable (or the parameter). Further, a value related to a variable (parameter) is also represented as a “value of a variable (parameter)” or a “variable (parameter) value”. A parameter value represents a value stored in a storage region identified by the parameter. For convenience of description, a value A of a parameter is also simply represented as a “parameter A”. Further, in the following description, a “parameter” and a “variable” may be used differently according to a described target, but the “parameter” and the “variable” represent similar contents.

Further, when a value of a random variable S is C, a conditional probability P that a random variable T is D is denoted as Eqn. A:

P(T=D|S=C) (Eqn. A)

Further, it is assumed that a value of a random variable is represented by using a subscript of the random variable as long as a misunderstanding is not caused. In this case, Eqn. A can be denoted as Eqn. B:

P(T=T_{D}|S=S_{C}) (Eqn. B)

Further, for convenience of description, it is assumed that the random variable S and the random variable T will be omitted as long as a misunderstanding is not caused. In this case, Eqn. B can be denoted as Eqn. C:

P(T_{D}|S_{C}) (Eqn. C)

Next, example embodiments of the present invention will be described in detail with reference to drawings.

### First Example Embodiment

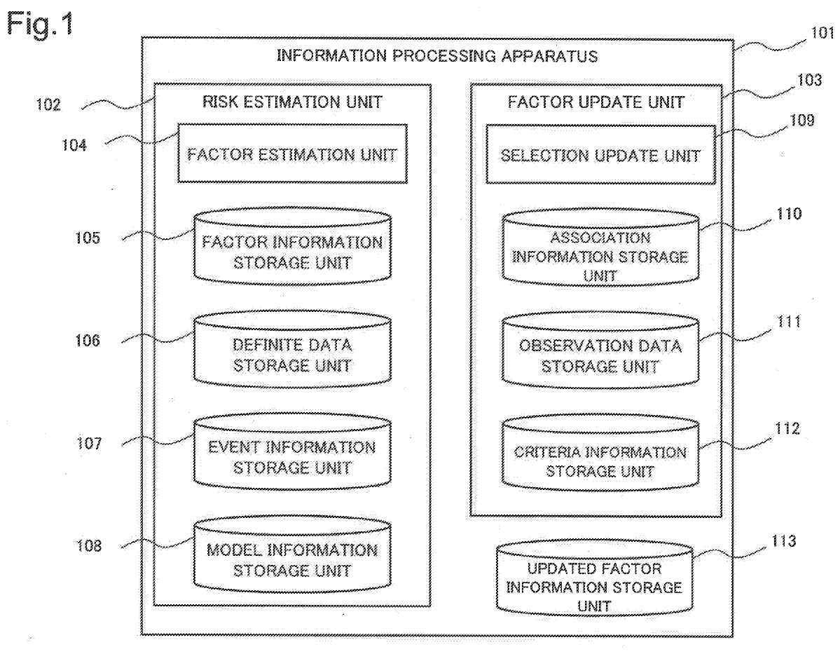

A configuration of an information processing apparatus 101 according to a first example embodiment of the present invention will be described in detail with reference to FIG. 1. FIG. 1 is a block diagram illustrating a configuration of the information processing apparatus 101 according to the first example embodiment of the present invention.

The information processing apparatus 101 according to the first example embodiment broadly includes a risk estimation unit (risk estimator) 102, a factor update unit (factor updater) 103, and an updated factor information storage unit 113. The risk estimation unit 102 includes a factor estimation unit (factor estimator) 104, a factor information storage unit 105, a definite data storage unit 106, an event information storage unit 107, and a model information storage unit 108. The factor update unit 103 includes a selection update unit (selection updater) 109, an association information storage unit 110, an observation data storage unit 111, and a criteria information storage unit 112.

The information processing apparatus 101 is able to estimate, for example, information about a target system having uncertainty (such as an event that occurs in the target system and a factor of occurrence of the event). The information processing apparatus 101 generates, for example, information about a target system related to each region as described above in the background art.

In the following description, a model generated in regard to a target system is represented as model information for convenience of description. The model information is, for example, a model that mathematically represents an event that occurs in the target system. It is assumed that at least one or more values of parameters (variables) included in the model information is comparable with observation data actually observed in regard to the target system, based on certain relevance. Specifically, a comparison may be able to be made via a model (observation model) that associates the parameter (variable) with observation data mathematically. Further, the information processing apparatus 101 treats a value of a parameter included in model information, a drive parameter (for example, a noise related to a target system) representing an influence on an event that occurs in the target system, and the like as a probability distribution, and, thereby, treats uncertainty of information represented by the parameter and the parameter. Further, in the following description, it is described on the assumption that information about a target system is information representing an event that occurs in the target system for convenience of description, but the information about the target system is not limited to the above-described example.

The model information storage unit 108 stores model information obtained by modeling an event that occurs in a target system. The model information includes a parameter of uncertainty occurred by modeling the target system and the like. The model information is, for example, a model that represents uncertainty occurred at generation of model information about a target system.

The definite data storage unit 106 stores an initial condition when processing is performed according to model information and data representing a value of a parameter (described later with reference to Eqn. 1) included in the model information. In the following description, the data are, for example, data taking an already defined value. The definite data storage unit 106 stores information such as a time interval in a simulation, a time from a start until a termination of the simulation, and an initial condition of the simulation, for example. Furthermore, the definite data storage unit 106 stores input information such as a value of data representing an initial condition given to the model information, a boundary condition of the model information, and a value of a parameter included in the model information. The input information represents, for example, information taking a definite value.

The model information includes a plurality of parameters representing a factor controllable from the outside (hereinafter represented as a “controllable parameter”) among factors affecting an event that occurs in a target system. Alternatively, when the target system is controlled via a factor represented by a controllable parameter, a plurality of pieces of observation data that may affect an event that occurs in the target system are included. For example, when event information is data relevant to a crop yield of a target crop, a value of a controllable parameter is, for example, data representing farming performed in a cultivated field for growing the target crop. A value of the controllable parameter is, for example, data observed in regard to an event that occurs in a target system in a period before decision making related to processing (for example, farming) performed in the target system, or data including a record of an observation result. Observation data are acquired as a result of observing an event that occurs in a target system, and thus a value of the controllable parameter can be regarded as factor information representing a cause of the occurrence of the event. In other words, the factor information is observation data observed in regard to a target system, or data estimated based on event information by the factor estimation unit 104. The factor information storage unit 105 stores the factor information.

The factor information storage unit 105 stores controllable data representing a factor controllable from the outside among factors affecting an event that occurs in a target system. The controllable data represent values of controllable parameters. A factor represented by the controllable data affects an event that occurs in the target system. Thus, in the following description, the controllable data may be represented as “factor information”, and data representing an event that occurs in the target system may be represented as “event information”. Therefore, a factor represented by the factor information occurs before an event represented by the event information.

The event information storage unit 107 stores event information representing an event that occurs in a target system. The event information may be data representing an event that occurs in a target system, or data representing an event estimated as an event that will occur in the target system.

The association information storage unit 110 stores association information that associates factor information with event information. The factor information and the event information are, for example, data estimated by the factor estimation unit 104. The observation data storage unit 111 stores observation data observed in regard to an event that occurs in a target system. The criteria information storage unit 112 stores, for example, criteria information representing selection criteria input from the outside. The selection criteria represent criteria for selecting specific association information from association information.

The updated factor information storage unit 113 stores association information that associates factor information with event information representing an event that occurs in a target system in case that a factor represented by the factor information occurs in the target system.

The observation data storage unit 111 stores observation data (namely, event information) observed in regard to a target system. The observation data represents, for example, data observed in regard to a target system after the target system is controlled in accordance with the factor information. The event information is, for example, data acquired by controlling a target system in accordance with factor information, or data representing a result estimated by the factor estimation unit 104, based on the factor information.

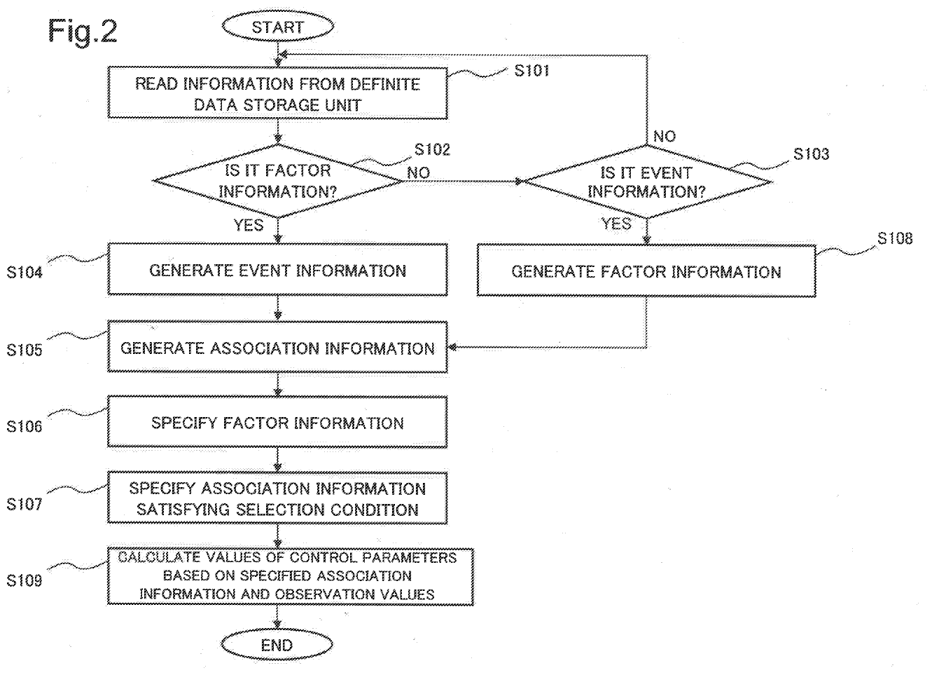

Processing in the information processing apparatus 101 according to the first example embodiment of the present invention will be described with reference to FIG. 2. FIG. 2 is a flowchart illustrating a flow of the processing in the information processing apparatus 101 according to the first example embodiment.

As described later with reference to each step of Steps S101 to S109, the information processing apparatus 101 performs risk estimation processing and a simulation based on model information.

The factor estimation unit 104 reads information (hereinafter represented as “definite information”) stored in the definite data storage unit 106 (Step S101). The factor estimation unit 104 determines whether or not the read definite information is factor information (Step S102). When the factor estimation unit 104 determines that the definite information is not factor information (NO in Step S102), the factor estimation unit 104 determines whether or not the definite information is event information (Step S103).

When the factor estimation unit 104 determines that the definite information is factor information (YES in Step S102), the factor estimation unit 104 generates event information by applying model information stored in the model information storage unit 108 to the factor information (Step S104, “event estimation process” described later). The factor estimation unit 104 stores the generated event information in the event information storage unit 107. The factor estimation unit 104 outputs the factor information and the generated event information to the factor update unit 103.

When the factor estimation unit 104 determines that the definite information is event information (YES in Step S103), the factor estimation unit 104 generates factor information based on the event information and model information (Step S108, “factor estimation process” described later). The factor estimation unit 104 stores the generated factor information in the factor information storage unit 105. The factor estimation unit 104 outputs the event information and the generated factor information to the factor update unit 103.

The processing in Steps S104 and S108 will be specifically described. In the risk estimation unit 102, the factor estimation unit 104 calculates a value as represented in Eqn. 3 or Eqn. 5 described later, and calculates relevance between a value uₜ of a controllable parameter (namely, factor information) and an observation value yᵣ (namely, event information), based on the calculated value.

One example of the event estimation process (namely, processing of generating event information based on factor information) indicated in Step S104 will be described.

In the event estimation process, uncertainty related to a target system can be treated as a probability distribution related to each parameter included in model information representing an event that occurs in the target system, a drive parameter representing information affecting an event that occurs in the target system, or a value of each parameter. In each of the example embodiments of the present invention, it is assumed that the model information is, for example, a state space model including a system model f indicated in Eqn. 1 and an observation model h indicated in Eqn. 2.

system model: xₜ=f(xₜ₋₁,0,uₜ,v) (Eqn. 1),

observation model: yₜ=h(xₜ,w) (Eqn. 2).

However, xₜ is a value of a state parameter representing a state of a target system at a timing t. xₜ₋₁ is a value of a state parameter representing a state of the target system at a time (t−1). θ represents a value of a parameter included in a system model. uₜ is a value of a controllable parameter (or factor information) related to the target system at the timing t. v represents, for example, a value of a drive parameter (drive term) representing an influence on an event that occurs in the target system. v represents, for example, a degree of a system noise generated at description of the above-described system model. The observation value yₜ represents observation data (observation information) observed in regard to the target system at the timing t, or represents event information representing an event that occurs in the target system. The observation model h represents relevance between the value xₜ of the state parameter and the observation value yₜ. w represents a difference between a calculation value of an observation value acquired by converting the value xₜ of the state parameter by the observation model h and the observation value yₜ representing observation data being actually observed. This difference may include both of uncertainty of the system model f and an observation error (observation noise).

A probability that the observation value yₜ occurs when factor information represented by the value uₜ of the controllable parameter related to the timing t occurs can be represented as a posterior probability of the value uₜ of the controllable parameter as indicated in Eqn. 3.

p(yₜ|uₜ) (Eqn. 3).

For example, a value of the posterior probability indicated in Eqn. 3 is obtainable by an ensemble simulation. The ensemble simulation is, for example, an iterative processing that includes a calculation of the value xₜ of the state parameter related to the value uₜ of the controllable parameter (factor information) in accordance with the processing indicated in Eqn. 1 and a calculation of the observation value yₜ (event information) for the calculated value xₜ of the state parameter in accordance with Eqn. 2. In a simulation based on a system model, the processing indicated in Eqn. 1 can be achieved as, for example, a direct problem for solving a simultaneous linear equation representing time development in timing order.

Examples of the ensemble simulation include an analytical technique of selecting the value xₜ of the state parameter in accordance with a normal (Gaussian) distribution, and obtaining the observation value yₜ (event information) in accordance with Eqn. 2 for a value of the selected value xₜ of the state parameter. Further, for example, there is a technique of obtaining the observation value yₜ in accordance with Eqn. 2 for each ensemble included in N ensemble sets (exemplified in Eqn. 4) related to the value xₜ of the state parameter in the ensemble simulation.

{x_{t,k}⁽ⁱ⁾} (Eqn. 4),

wherein, k represents a natural number indicating k^{th} state parameter included in the value xₜ of the state parameter. i represents a natural number that satisfies 1≤i≤N.

In the ensemble simulation, the observation value yₜ (event information) is individually (or simultaneously) obtainable for the value xₜ of each state parameter. The event estimation process is not limited to the above-described processing procedure.

One example of the factor estimation process (namely, processing of generating factor information based on event information) indicated in Step S108 will be described.

The system model indicated in Eqn. 1 is a model including uncertainty. Thus, in the factor estimation process, a probability that the value of the controllable parameter is the value uₜ when the observation value yₜ (event information) being an actual value of observation data at the timing t is given can be represented as the posterior probability of the observation value yₜ as indicated in Eqn. 5.

p(uₜ|yₜ) (Eqn. 5).

The processing procedure in accordance with Eqn. 5 is achievable by a processing procedure for obtaining the value uₜ of the controllable parameter (factor information), based on the observation value yₜ (event information) in accordance with the simultaneous linear equation of the time development related to the model information indicated in Eqns. 1 and 2. However, the processing procedure is different from the event estimation process of obtaining the observation value yₜ (event information), based on the value uₜ of the controllable parameter (factor information). The factor estimation process roughly includes a direct problem approach and an inverse problem approach. The direct problem approach is a procedure for searching for a value uₜ of a controllable parameter (factor information) that is to be closer to a given observation value yₜ (event information), and is a processing procedure such as a genetic algorithm, for example. The inverse problem approach is a procedure for, for example, previously inputting a plurality of patterns in which a value uₜ of a controllable parameter (factor information) appears, and filtering the value uₜ of the controllable parameter (factor information) that gives an observation value yₜ (event information) (or event information similar to the value yₜ) among the patterns. The inverse problem approach can be achieved in accordance with a predetermined processing procedure such as sequential Bayesian filtering, data assimilation, and a Markov Chain Monte Carlo method, for example. The factor estimation process is not limited to the above-described processing procedure.

The risk estimation unit 102 may perform processing in accordance with equation (for example, Eqns. 1 and 2) representing model information, for example. Alternatively, the risk estimation unit 102 may be achieved by using a simulator that simulates an event that occurs in the target system, and the like.

After the event estimation process indicated in Step S104 in FIG. 2 or the factor estimation process indicated in Step S108, the factor update unit 103 inputs the factor information and the event information output from the risk estimation unit 102. The factor update unit 103 generates association information that associates the input factor information with the input event information (Step S105) and stores the generated association information in the association information storage unit 110. Hereinafter, the processing in Step S105 is represented as “prior risk estimation processing”. The processing of generating association information may be performed for a timing in a future period, for example.

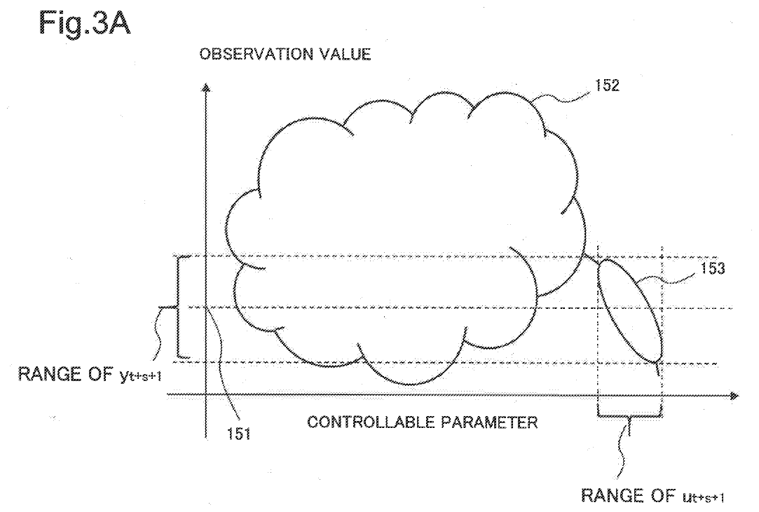

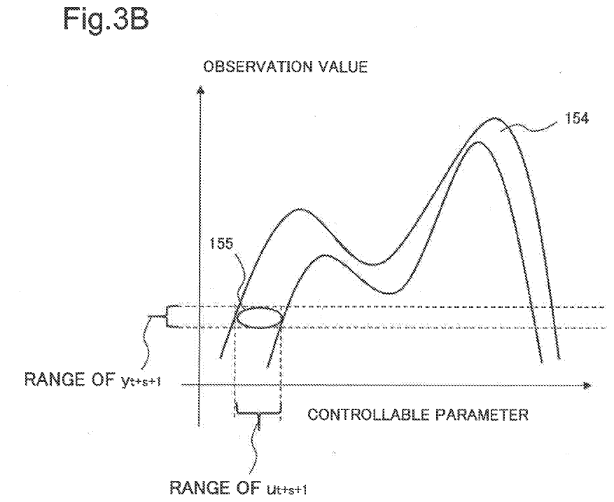

In the association information, factor information (a value of a controllable parameter) may be associated with event information (an observation value) for not only one timing but also a plurality of timings (for example, a timing before the timing t described later). When factor information is associated with event information in association information for a plurality of timings, for example, as illustrated in FIG. 3B, a value of a controllable parameter is associated with an observation value for a plurality of timings in the association information. The association information represents relevance that the event information (representing an observation value) occurs in a case where, for example, the factor information (representing a value of a controllable parameter) occurs at a certain timing. Alternatively, the association information represents relevance that the factor information (representing a value of a controllable parameter) occurs in a case where the event information (representing an observation value) occurs at a certain timing. Hereinafter, the processing of generating the association information is represented as “prior risk estimation” processing.

For convenience of description, a timing of factor information (or event information) calculated by the risk estimation unit 102 is represented as “t” (t is a natural number). Further, it is assumed that the observation data storage unit 111 stores an observation value yₜ₊ₛ (event information) (s is a natural number) observed after the timing t in real time, for example. However, a timing of storing event information may not be always real time. It is assumed that the criteria information storage unit 112 stores criteria information that can be input from an external device and the like. The criteria information is stored as information representing a selection condition (criterion) being a basis for selecting specific association information from association information stored in the association information storage unit 110. The criteria information represents, for example, criteria for a range of the value uₜ of the controllable parameter (factor information), or a range of the calculated (or observed) observation value yₜ (event information) versus a deviation from a set value, or stability and tolerance such as a small deviation from a target value. As another example, the criteria information may represent criteria in such a way that a value that may be taken by the observation value versus a controllable parameter is less than or equal to a certain predetermined value, or greater than or equal to a predetermined value, or a group of specific discrete values. The criteria information can be represented by using, for example, a ratio of a range of the observation value yₜ to a range of a value of a controllable parameter. It is assumed that the risk estimation unit 102 calculates a value (factor information uₜ₊ₛ₊₁) at a future timing “t+s+1” (s is a natural number) of a controllable parameter, based on event information (namely, the observation value yₜ₊ₛ) at a timing “t+s” (s is a natural number) after the timing t and model information stored in the model information storage unit 108. Details of the processing will be described.

The selection update unit 109 specifies controllable parameter (factor information) value at a timing when an observation value is the value “yₜ₊ₛ” by performing processing similar to the above-descried processing in Step S108 in accordance with model information stored in the model information storage unit 108 (Step S106). In other words, when an observation value is the value yₜ₊ₛ, the selection update unit 109 calculates a probability (Eqn. 6) that a value of a controllable parameter is the value uₜ₊ₛ₊₁ according to model information stored in the model information storage unit 108.

p(uₜ₊ₛ₊₁|yₜ₊ₛ) (Eqn. 6).

Next, the selection update unit 109 specifies association information (or a value) that satisfies a selection condition represented by the read criteria information among association information stored in the association information storage unit 110 for the value yₜ₊ₛ and the calculated value uₜ₊ₛ₊₁ (Step S107). When the selection condition is a condition for stability and tolerance as described above, the selection update unit 109 specifies, for example, association information that satisfies a selection condition that a range (a scatter degree) of the calculated observation value (or a deviation from a target value) is smaller than a range (a scatter degree) of the value of the control parameter (or a deviation from a set value) among association information stored in the association information storage unit 110. By performing processing similar to the processing as described above in Step S108 for the observation value (a set of the values is presented as a “set Rc” for convenience of description) included in the specified association information and the observation value yₜ₊ₛ, the selection update unit 109 calculates a value of the control parameter (factor information) related to the value (Step S109). In this case, the selection update unit 109 calculates a conditional probability (Eqn. 7) of the value uₜ₊ₛ₊₁ of the controllable parameter when the observation value yₜ₊ₛ and the set Rc are given.

p(uₜ₊ₛ₊₁|yₜ₊ₛ,Rc) (Eqn. 7).

Therefore, the information processing apparatus 101 sets the appropriate set Rc as a value that may be taken by the controllable parameter by the processing indicated in Steps S107 and S109, based on the criteria information and the specific association information. The information processing apparatus 101 calculates a value of the control parameter related to the value yₜ₊ₛ, based on the set Rc being set and the estimated value calculated by using the model information.

The observation value yₜ₊ₛ referred to in Step S109 may be, for example, read in Step S107, or read in Step S109. The processing of reading the observation value yₜ₊ₛ is not limited to the above-described example.

With reference to FIGS. 3A and 3B, an influence of presence or absence of the prior risk estimation processing on association information representing relevance between observation data and controllable data will be described. FIG. 3A is a diagram representing relevance between an observation value when the prior risk estimation is not performed and a value of a controllable parameter (observation value). FIG. 3B is a diagram representing relevance between an observation value when the prior risk estimation processing is performed and a value of a controllable parameter, similarly to the processing in the information processing apparatus 101 according to the present example embodiment.

In FIGS. 3A and 3B, a horizontal axis represents a controllable parameter, and represents a greater value of a controllable parameter (control value) farther toward a right side. In FIGS. 3A and 3B, a vertical axis represents an observation value, and represents a greater observation value farther toward an upper side.

A plurality of control values that may achieve one event that occurs in a target system may be present in regard to the target system being an estimated object of the information processing apparatus 101 according to the present example embodiment. For a technique in which the prior risk estimation processing is not performed, a value uₜ₊ₛ₊₁ of a controllable parameter at a next timing (t+s+1) calculated according to Eqn. 6 is calculated based on a latest observation value yₜ₊ₛ acquired at a new timing (t+s). Further, in the technique, an observation value vₜ₊ₛ₊₁ (a value 151 in FIG. 3A) is predicted based on the calculated parameter value uₜ₊ₛ₊₁. As exemplified in a region 153, a relevance between the observation value yₜ₊ₛ₊₁ and the value uₜ₊ₛ₊₁ of the controllable parameter may be unstable. The reason is that, as indicated in the region 152, the target system does not necessarily calculate relevance between an observation value for the target system and the control value at a low risk. In other words, the target system for performing processing in accordance with the technique in which the prior risk estimation is not performed may calculate only a part of relevance among the relevance.

In contrast, the information processing apparatus 101 according to the present example embodiment performs the above-described processing, based on an estimation result calculated by the factor estimation process or the event estimation process. The estimation result is information generated by the information processing apparatus 101 according to the processing described with reference to FIG. 2.

The information processing apparatus 101 according to the present example embodiment selects association information (association information 154 in FIG. 3B) that satisfies a selection condition for stability such as a narrow range of an estimated value for the observation value versus a range of a value of a controllable parameter, for example, in regard to relevance stored in the association information storage unit 110. Subsequently, the information processing apparatus 101 calculates, in accordance with Eqn. 5, a conditional probability of the controllable parameter when an observation value (hereinafter represented as an “observation anticipated value”) included in the association information is give. Therefore, the information processing apparatus 101 calculates a value related to controllable data uₜ₊ₛ₊₁ as indicated in Eqn. 7 described above, based on a control value included in the association information, a set Rc of the selected observation anticipated value, and the latest observation value yₜ₊ₛ acquired at the new timing (t+s).

Therefore, the information processing apparatus 101 specifies factor information (namely, the value uₜ₊ₛ₊₁ of the controllable parameter) representing a factor of an event represented by the event information, based on the set Rc of the selected observation anticipated value and the observation value yₜ₊ₛ (event information). As a result, the information processing apparatus 101 is able to calculate the factor information (the value uₜ₊ₛ₊₁ of the controllable parameter indicated in the region 155 in FIG. 3B) at a low risk. With reference to FIGS. 3A and 3B, relevance (for example, a ratio) between a range of the value uₜ₊ₛ₊₁ of the controllable parameter and a range of the observation value yₜ₊ₛ₊₁ will be described in more detail. The region 153 in FIG. 3A and the region 155 in FIG. 3B represent a range bound. The relevance can be calculated as, for example, a ratio of a range of the observation value yₜ₊ₛ₊₁ to a range of the controllable parameter value uₜ₊ₛ₊₁.

In comparison between the relevance in the region 155 and the relevance in the region 153, the relevance in the region 155 is smaller. Therefore, stable relevance can be acquired when the prior risk estimation is performed as compared to a case where the prior risk estimation is not performed. This represents that a predicted distribution of an observation value when the prior risk estimation is performed is narrower than that when the prior risk estimation is not performed. The predicted distribution of value is predicted for a distribution of a value of a controllable parameter at a next step and the controllable parameter is estimated based on a latest observation value. In other words, this represents that information having a less risk can be provided when the prior risk estimation is performed as compared to a case where the prior risk estimation is not performed.

The information processing apparatus 101 performs processing of calculating a value of controllable data in accordance with a processing procedure such as online (sequential) Bayesian filtering and data assimilation, for example. The processing of calculating a value related to a control value by the information processing apparatus 101 is not limited to the above-described example.

In other words, the factor update unit 103 is able to calculate, based on a selection condition, an optimum control value at a time step next to a timing at which observation data are newly acquired among relevance between a control value based on a prior risk estimation result and an estimated value of an observation value. In contrast, when the prior risk estimation processing is not performed, an optimum control value cannot be calculated. The factor update unit 103 stores the calculated observation value as new factor information in the updated factor information storage unit 113. The new factor information is data being a basis of estimating a risk after the next time step (the timing (t+s+1) in the case of this example).

Next, an advantageous effect of an information processing apparatus 101 according to the first example embodiment of the present invention will be described.

The information processing apparatus 101 according to the first example embodiment is able to provide estimation information having a low risk. The reason is that a value of a parameter in model information representing an event that occurs in a target system is adjusted based on observation data observed in regard to the target system, and the event that occurs in the target system is estimated based on the adjusted value of the parameter. This reason will be described in more detail.

For example, in processing of calculating a probability related to event information when certain factor information is given, a probability of event information unobserved in the past cannot be properly calculated when a target is only event information that has actually occurred on the certain factor information. Further, when model information of a target system does not reflect uncertainty although the target system has the uncertainty, estimation accuracy based on the model information is insufficient. Thus, event information estimated in accordance with the model information cannot necessarily generate event information about the certain factor information properly. The information processing apparatus 101 according to the first example embodiment performs processing based on model information that reflects uncertainty, and thus the risk estimation unit 102 can generate event information that has not been acquired in the past and event information that has not been specified. Therefore, model information being a processed target in the risk estimation unit 102 reflects an error and the like that occur due to insufficient estimation accuracy of the model information, and thus the information processing apparatus 101 according to the first example embodiment can predict an event that occurs in a target system at a low risk.

Similarly, in processing of calculating a posterior probability of factor information when certain event information occurs, a probability of factor information that has not been observed in the past cannot be properly calculated when a target is only factor information that has actually occurred on the certain event information. Further, when factor information about the event information is generated based on model information that does not take uncertainty into consideration, estimation accuracy of a simulation based on the model information is insufficient. Thus, factor information about the certain event information cannot necessarily be generated properly.

Therefore, the risk estimation unit 102 is able to generate event information that has not been acquired in the past and factor information that has not been specified. In other words, the risk estimation unit 102 is able to generate factor information having a low risk by processing that takes into account an influence caused by insufficient estimation accuracy of model information.

The information processing apparatus 101 may generate association information and the like, based on a factor represented by using a probability and an event represented by using a probability in the factor estimation process and the event estimation process. In other words, in the information processing apparatus 101, uncertainty related to a target system is treated as a probability distribution of each parameter included in model information representing an event that occurs in the target system, a drive parameter representing information affecting an event that occurs in the target system, or a value of each parameter.

### Second Example Embodiment

Next, a second example embodiment of the present invention based on the above-described first example embodiment will be described.

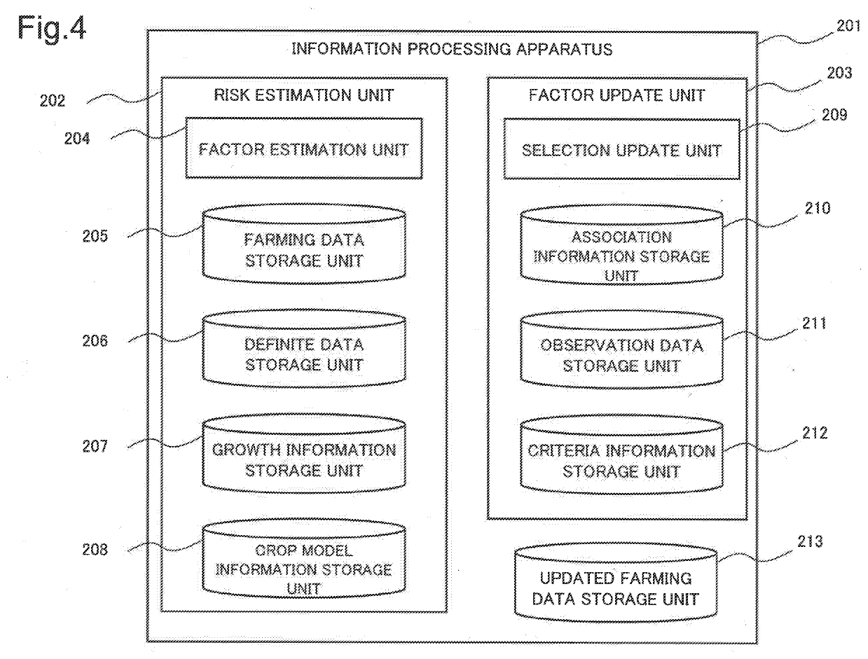

A configuration of an information processing apparatus 201 according to the second example embodiment of the present invention will be described in detail with reference to FIG. 4. FIG. 4 is a block diagram illustrating a configuration of the information processing apparatus 201 according to the second example embodiment of the present invention.

The information processing apparatus 201 according to the second example embodiment broadly includes a risk estimation unit (risk estimator) 202, a factor update unit (factor updater) 203, and an updated farming data storage unit 213. The risk estimation unit 202 includes a factor estimation unit (factor estimator) 204, a farming data storage unit 205, a definite data storage unit 206, a growth information storage unit 207, and a crop model information storage unit 208. The factor update unit 203 includes a selection update unit (selection updater) 209, an association information storage unit 210, an observation data storage unit 211, and a criteria information storage unit 212.

The crop model information storage unit 208 stores model information including a parameter representing uncertainty of a target system, such as crop model representing an event that occurs for a target crop, for example.

A crop model stored in the crop model information storage unit 208 is one example of model information. The crop model includes a parameter such as a leaf area index (LAI), for example. Processing of generating information representing a growth state of a target crop can be performed based on, for example, the LAI according to the crop model. It is known that the LAI has a correlation with a vegetation index (VI). Information representing a growth state of a target crop can be generated based on data defined as an input to a crop model, such as geographical data, weather data, farming data, or various model parameters, in accordance with the LAI. The crop model is, for example, a Decision Support System for Agrotechnology Transfer (DSSAT), the Agricultural Production Systems siMulator (APSIM), or WOrld FOod STudies (WOFOST).

The definite data storage unit 206 stores information such as an initial condition given to the crop model of a target crop, a parameter included in the crop model, and weather data of an area for growing the target crop.

The farming data storage unit 205 stores a value of a controllable parameter (for example, farming data representing an irrigation timing, an irrigation amount, a fertilization timing, and an fertilizer amount) in the crop model. The value of the parameter is one example of the above-described factor information.

The growth information storage unit 207 stores data about a target crop (for example, a size of a target crop and a crop yield of a target crop). The data stored in the growth information storage unit 207 may be data observed in regard to the target crop, or may be event information (namely, an estimated value of observation data) estimated based on factor information such as farming data.

The association information storage unit 210 stores association information that associates a value of a controllable parameter (factor information) in a crop model with data about a target crop such as a crop yield of the target crop. The data about the target crop is, for example, data similar to data stored in the observation data storage unit 211 described above.

The observation data storage unit 211 stores, for example, data observed (measured) by a satellite about a cultivated field for growing a target crop, data observed by a field sensor installed in the cultivated field, or the like.

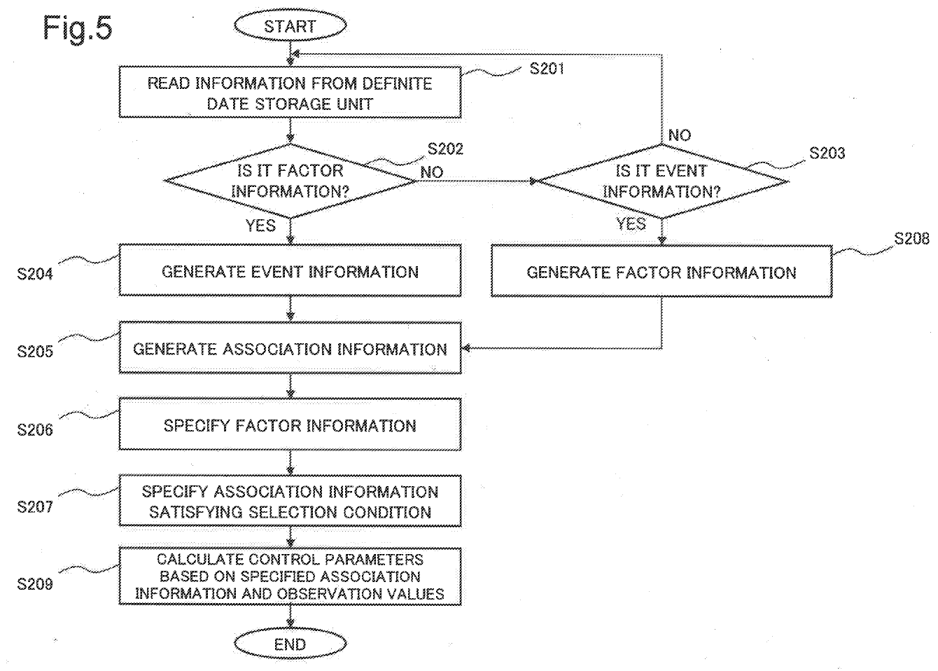

The observation data storage unit 211 stores observation data representing a growth state of a target crop. As the observation data, for example, a normalized difference vegetation index (NDVI) that can be used as the VI may be used. An NDVI value can be calculated based on a reflectance in a visible red band and a reflectance in a near infrared band. The selection update unit 209 inputs a vegetation index NDVI as observation data, and performs processing (described later with reference to FIG. 5) similar to the processing as described with reference to FIG. 2, based on the input observation data. The observation data and the parameter included in the model are not limited to the above-described examples.

The NDVI can be calculated based on data observed by using a radiometer sensor (MODerate resolution Imaging Spectroradiometer: MODIS) that is able to observe a visible region and an infrared region installed on a Terra satellite or an Aqua satellite and the like, for example. The processing will be described more specifically.

The MODIS installed on the Terra satellite (or Aqua satellite) is able to observe intensity of reflected light acquired by sunlight being reflected on the earth's surface in a visible red band (having a wavelength of 0.58 micrometer (μm) to 0.86 μm) and a near infrared band (having a wavelength of 0.725 μm to 1.100 μm). The MODIS installed on the Terra satellite (or Aqua satellite) observes intensity of the reflected light every day, but has only a spatial resolution of about 250 meters (m) related to the earth's surface. Furthermore, the observation data may be data observed by using a LANDSAT, a PLEIADES satellite, an ASNARO satellite, a RapidEye satellite, a Sentinel satellite, and the like.

The LANDSAT represents an abbreviation for LAND SATellite. The ASNARO represents an abbreviation for Advanced Satellite with New system Architecture for Observation.

A measureable wave range of these satellites is almost the same as a measureable wave range of the MODIS installed on the Terra satellite (or AQUA satellite). However, the LANDSAT observes observation data at intervals of 8 to 16 days, and has a spatial resolution of about 30 meters related to the earth's surface. The PLEIADES satellite and the ASNARO satellite observe observation data at intervals of 2 to 3 days, and have a spatial resolution of about 2 meters related to the earth's surface. A captured image being a basis of calculating a VI may be an image including a visible red band and a near infrared band. However, a wave range acquired as observation data is not limited to these bands.

The criteria information storage unit 212 stores criteria information representing a selection condition that is a condition for selecting specific association information from association information. The criteria information may be input from the outside. The updated farming data storage unit 213 stores factor information (namely, a value of a controllable parameter) calculated by the selection update unit 209. Further, the definite data storage unit 206 stores information such as geographical data, weather data, farming data, or various model parameters.

Processing in the information processing apparatus 201 according to the second example embodiment of the present invention will be described with reference to FIG. 5. FIG. 5 is a flowchart illustrating a flow of the processing in the information processing apparatus 201 according to the second example embodiment.

The factor estimation unit 204 reads definite information stored in the definite data storage unit 206 (Step S201). The factor estimation unit 204 determines whether or not the read definite information is factor information (for example, information representing an irrigation amount) (Step S202). When the factor estimation unit 204 determines that the definite information is not factor information (NO in Step S202), the factor estimation unit 204 determines whether or not the definite information is event information (for example, information representing a size of a target crop) (Step S203).

When the factor estimation unit 204 determines that the definite information is factor information (YES in Step S202), the factor estimation unit 204 generates event information by applying model information stored in the crop model information storage unit 208 to the factor information (Step S204). The processing in Step S204 is processing similar to that in Step S104 in FIG. 2, and thus detailed description will be omitted in the present example embodiment. In Step S204, the factor estimation unit 204 estimates a size of a target crop, based on, for example, a timing of irrigation operation in a cultivated field for growing the target crop and an irrigation amount in the irrigation operation, and generates event information representing the estimated size. The factor estimation unit 204 stores the generated event information in the growth information storage unit 207. The factor estimation unit 204 outputs the factor information and the generated event information to the factor update unit 203. In addition, the present example embodiment includes, as factors, a fertilization timing, a fertilizer amount in the fertilization, and the like. Further, in addition, the present example embodiment may include, as event information, a weight of a target crop, an amount representing a growth degree such as an LAI, an amount representing healthiness of growth such as a leaf nitrogen concentration, an amount representing quality such as a sugar content, and a crop yield per unit area.

When the factor estimation unit 204 determines that the definite information is event information (YES in Step S203), the factor estimation unit 204 generates factor information, based on the event information and model information (Step S208). The processing in Step S208 is processing similar to that in Step S108 in FIG. 2, and thus detailed description will be omitted in the present example embodiment. In Step S208, the factor estimation unit 204 estimates a timing of an irrigation operation on a cultivated field and an irrigation amount, based on, for example, a size of a target crop grown in the cultivated field, and generates factor information representing the irrigation amount of and the timing. The factor estimation unit 204 stores the generated factor information in the farming data storage unit 205. The factor estimation unit 204 outputs the event information and the generated factor information to the factor update unit 203.

The factor update unit 203 inputs the factor information and the event information output from the risk estimation unit 202. The factor update unit 203 generates association information that associates the input factor information with the input event information (Step S205), and stores the generated association information in the association information storage unit 210.

The factor update unit 203 generates, in accordance with model information, factor information about observation data (event information) observed for a target crop (Step S206). The processing in Step S206 is processing similar to that in Step S106 in FIG. 2, and thus detailed description will be omitted in the present example embodiment. The factor update unit 203 specifies association information that satisfies a selection condition represented by criteria information stored in the criteria information storage unit 212 among association information stored in the association information storage unit 210, based on the specified factor information (Step S207). The processing in Step S207 is processing similar to that in Step S107 in FIG. 2, and thus detailed description will be omitted in the present example embodiment.

The factor update unit 203 specifies, based on event information representing an event observed in regard to a target system, event information included in the association information specified in Step S204, an observation value (a value included in the set Rc described above) included in the specified association information, and an observation value yₜ₊ₛ, factor information about the event (Step S209). The processing in Step S209 is processing similar to that in Step S109 in FIG. 2, and thus detailed description will be omitted in the present example embodiment. The factor update unit 203 may further calculate a probability that the factor information as indicated in Eqn. 5 occurs. For example, the factor update unit 203 specifies, based on a size observed in regard to a target crop and a size included in association information that satisfies a selection condition, a timing of an irrigation operation and an irrigation amount that represent factors of occurrence of these sizes.

Therefore, the information processing apparatus 201 according to the second example embodiment calculates an event of farming (for example, a risk of a crop yield decrease of a target crop), based on factor information (for example, farming data such as irrigation or fertilization). Furthermore, the information processing apparatus 201 calculates a control value (an irrigation amount, an irrigation timing, an fertilizer amount, and a fertilization timing in this example) that satisfies appropriate a selection condition (maximization of a crop yield of a target crop in this example), based on observed observation data (for example, a growth state of the target crop, a state of soil, and the like). The selection condition may be a condition representing minimization of investment materials such as irrigation and fertilization, for example.

Next, an advantageous effect of the information processing apparatus 201 according to the second example embodiment of the present invention will be described.

The information processing apparatus 201 according to the second example embodiment is able to provide estimation information having a low risk. This reason is a reason similar to the reason described in the first example embodiment.

Furthermore, the information processing apparatus 201 according to the present example embodiment is able to provide estimation information having a low risk about agriculture. This reason is that the information processing apparatus 201 performs processing, based on information about agriculture.

The model information may not be necessarily the crop model described above. Further, the observation data may not be data representing a growth state of a target crop. In other words, the crop model, the observation data, and the like are not limited to the above-described examples. For example, the information processing apparatus 201 according to the present example embodiment is also able to generate information having high estimation accuracy about three regions exemplified below, for example.
A resource target system such as water, fossil fuel, or natural energy, a weather system, or a climate system,
a medical system or a health care system having high uncertainty due to a biological influence and an influence of an individual difference,
a traffic system or a distribution system having high uncertainty due to an influence of a human operation.

In each of the above-described example embodiments, the risk estimation unit (the risk estimation unit 102 and the risk estimation unit 202) may generate association information with less frequency than a frequency of observing observation information. When the factor update unit (the factor update unit 103 and the factor update unit 203) performs processing at observation of observation information, an interval of timing of generation of association information by the risk estimation unit generates may be longer than an interval of timing of processing of the factor update unit. In this case, the risk estimation unit performs the above-described processing after an elapse of an interval longer than an interval of timing of the processing by the factor update unit. The longer interval reduces a frequency of the processing by the risk estimation unit, and thus an advantageous effect of reducing processing amount in the information processing apparatus (the information processing apparatus 101 or the information processing apparatus 201) can be achieved.

### Third Example Embodiment

Next, a third example embodiment of the present invention will be described.

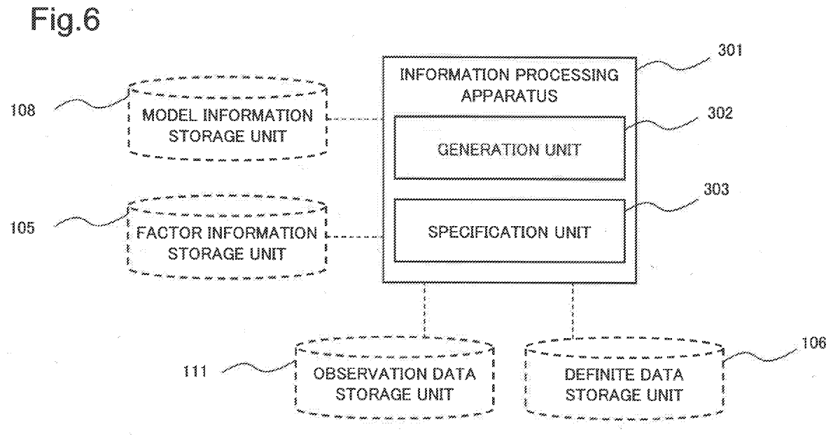

A configuration of an information processing apparatus 301 according to the third example embodiment of the present invention will be described in detail with reference to FIG. 6. FIG. 6 is a block diagram illustrating a configuration of the information processing apparatus 301 according to the third example embodiment of the present invention.

The information processing apparatus 301 according to the third example embodiment includes a generation unit (generator) 302 and a specification unit (specifier) 303.

The information processing apparatus 301 is connected or is communicably connected to an observation data storage unit 111, a definite data storage unit 106, and a model information storage unit 108.

It is assumed for convenience of description that the definite data storage unit 106 stores event information representing an event that occurs in a target system.

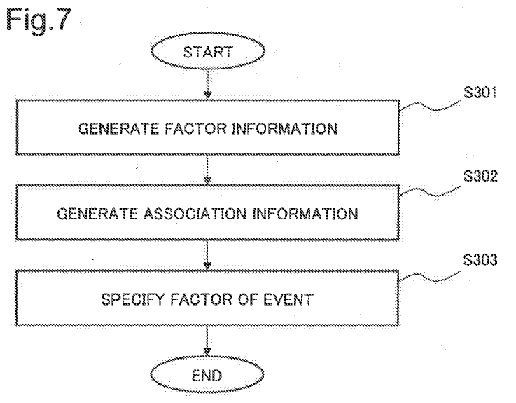

Processing in the information processing apparatus 301 according to the third example embodiment of the present invention will be described with reference to FIG. 7. FIG. 7 is a flowchart illustrating a flow of the processing in the information processing apparatus 301 according to the third example embodiment.

The generation unit 302 reads event information stored in the definite data storage unit 106 and model information stored in the model information storage unit 108. The model information is a model representing relevance between an event that occurs in a target system and a factor of occurrence of the event as described with reference to FIG. 1, for example. The generation unit 302 specifies a factor of occurrence of an event represented by the read event information, and generates factor information representing the specified factor (Step S301).

Alternatively, in Step S301, the generation unit 302 reads factor information stored in the factor information storage unit 105 and model information stored in the model information storage unit 108. The generation unit 302 may generate event information by applying the model information to the read factor information. In other words, in Step S301, the generation unit 302 provides any one of an event and a factor to model information representing relevance between an event occurred on a target and a factor occurring before the event, and estimates the other.

The processing in Step S301 is processing similar to the processing indicated in Step S108 in FIG. 2, Step S208 in FIG. 5, or the like, and thus detailed description will be omitted in the present example embodiment. The generation unit 302 generates association information that associates the read event information with the specified factor information (Step S302). Alternatively, the generation unit 302 generates association information that associates the read factor information with the estimated event information.

In other words, in Step S302, the generation unit 302 generates association information that associates first event information representing an event acquired as an estimation result with first factor information representing a given factor, or association information that associates second event information representing a given event with second factor information representing a factor acquired as an estimation result.

The specification unit 303 inputs association information generated by the generation unit 302 and event information about a target system. The association information input by the specification unit 303 may be, for example, association information that satisfies a selection condition among association information generated by the generation unit 302. The event information about the target system is stored in the observation data storage unit 111, and is, for example, event information representing an event observed in the target system. The specification unit 303 specifies a factor of an event represented by the input event information, based on the input association information and the input event information (Step S303). The processing in Step S303 is processing similar to the processing described with reference to Eqns. 6 or 7, for example, and thus detailed description will be omitted in the present example embodiment.

Therefore, the generation unit 302 can be achieved by a function similar to the function of the factor estimation unit 104 illustrated in FIG. 1 or the factor estimation unit 204 illustrated in FIG. 4. The specification unit 303 can be achieved by a function similar to the function of the factor update unit 103 illustrated in FIG. 1 or the factor update unit 203 illustrated in FIG. 4. Further, the information processing apparatus 301 can be achieved by a function similar to the function of the information processing apparatus 101 illustrated in FIG. 1 or the information processing apparatus 201 illustrated in FIG. 4.

Next, an advantageous effect of the information processing apparatus 301 according to the third example embodiment of the present invention will be described.

The information processing apparatus 301 according to the third example embodiment is able to provide estimation information having a low risk. The reason is that a value of a parameter in model information representing an event that occurs in a target system is adjusted based on observation data observed in regard to the target system, and the event that occurs in the target system is estimated according to the adjusted value of the parameter.

(Hardware Configuration Example)

A configuration example of hardware resources that achieve an information processing apparatus according to each example embodiment of the present invention will be described. However, the information processing apparatus may be achieved using physically or functionally at least two calculation processing apparatuses. Further, the information processing apparatus may be achieved as a dedicated apparatus.

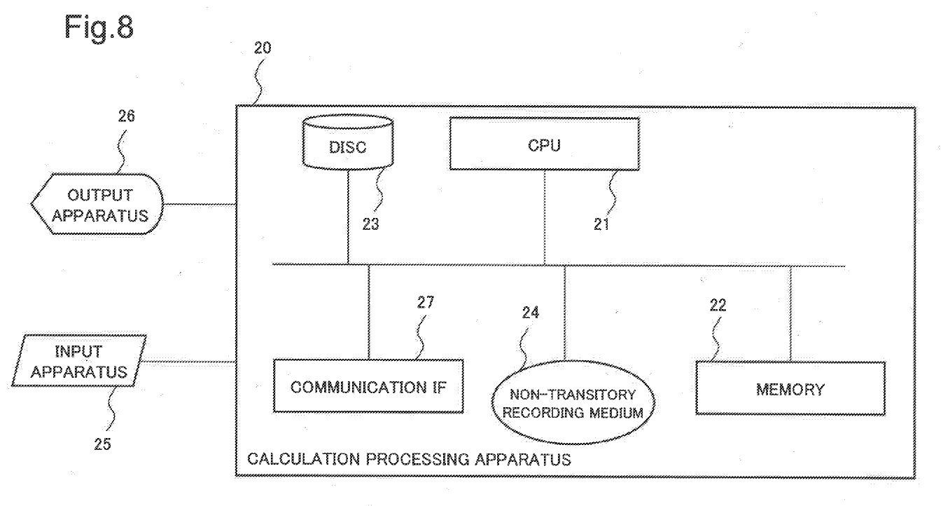

FIG. 8 is a block diagram schematically illustrating a hardware configuration of a calculation processing apparatus capable of achieving an information processing apparatus according to each example embodiment of the present invention. A calculation processing apparatus 20 includes a central processing unit (CPU) 21, a memory 22, a disk 23, a non-transitory recording medium 24, and a communication interface (hereinafter, refer to “communication IF”) 27. The calculation processing apparatus 20 may connect an input apparatus 25 and an output apparatus 26. The calculation processing apparatus 20 can execute transmission/reception of information to/from another calculation processing apparatus and a communication apparatus via the communication I/F 27.

The non-transitory recording medium 24 is, for example, a computer-readable Compact Disc, Digital Versatile Disc. The non-transitory recording medium 24 may be Universal Serial Bus (USB) memory, Solid State Drive or the like. The non-transitory recording medium 24 allows a related program to be holdable and portable without power supply. The non-transitory recording medium 24 is not limited to the above-described media. Further, a related program can be carried via a communication network by way of the communication I/F 27 instead of the non-transitory recording medium 24.

In other words, the CPU 21 copies, on the memory 22, a software program (a computer program: hereinafter, referred to simply as a “program”) stored in the disk 23 when executing the program and executes arithmetic processing. The CPU 21 reads data necessary for program execution from the memory 22. When display is needed, the CPU 21 displays an output result on the output apparatus 26. When a program is input from the outside, the CPU 21 reads the program from the input apparatus 25. The CPU 21 interprets and executes an information processing program (FIG. 2, FIG. 5, or FIG. 7) present on the memory 22 corresponding to a function (processing) indicated by each unit illustrated in FIG. 1, FIG. 4, or FIG. 6 described above. The CPU sequentially executes the processing described in each example embodiment of the present invention.

In other words, in such a case, it is conceivable that the present invention can also be made using the information processing program. Further, it is conceivable that the present invention can also be made using a computer-readable, non-transitory recording medium storing the information processing program.

The present invention has been described using the above-described example embodiments as example cases. However, the present invention is not limited to the above-described example embodiments. In other words, the present invention is applicable with various aspects that can be understood by those skilled in the art without departing from the scope of the present invention.

A part of or all of the above-described example embodiments may be described as the following supplementary notes. However, the present invention exemplarily described in the above-described example embodiments is not limited to the following.

(Supplementary Note 1)

An information processing apparatus comprising:

generation means for estimating one of event and factor by giving model information the other, and generating association information, the model information representing relevance between an event that occurs on a target and the factor that occurs before the event, the association information associating first event information that represents the event obtained as the estimation result with first factor information that represents the given factor or associating second event information that represents the given event with second factor information that represents the factor obtained as the estimation result; and

specification means for specifying the factor of third event information representing an event occurred on the target based on the model information by using the third event information and, at least, one of the first event information and the second event information included in the association information.

(Supplementary Note 2)

The information processing apparatus according to supplementary note 1, wherein

the specification means selects a piece of association information among the association information in accordance with a selection condition of selecting the piece of association information and specifies the factor of the third event information by using the first event information or the second event information included in the selected piece of association information, and the third event information.

(Supplementary Note 3)

The information processing apparatus according to supplementary note 2, wherein

the selection criteria represents a condition that a scatter degree of the first event information or the second event information is smaller than a scatter degree of the first factor information or the second factor information.

(Supplementary Note 4)

The information processing apparatus according to any one of supplementary notes 1 to 3, wherein

the generation means calculates, as the first event information, possibility of the event occurred by the factor or calculates, as the second factor information, possibility of the factor that has occurred when the event occurs.

(Supplementary Note 5)

The information processing apparatus according to supplementary note 4, wherein

the generation means generates a plurality of the association information, the association information associating a plurality of the first factor information with a plurality of the first event information in case of each of the first factor information or associating a plurality of the second factor information with a plurality of the second event information in case of each of the plurality of the second factor information.

(Supplementary Note 6)

The information processing apparatus according to any one of supplementary notes 1 to 5, wherein

the specification means selects one of the first factor information or the second factor information based on the association information and specifies, as the factor, a factor represented by the selected factor information.

(Supplementary Note 7)

The information processing apparatus according to supplementary note 6, wherein

the specification means specifies the factor by executing processing in accordance with sequential Bayesian filtering, data assimilation, or Markov Chain Monte Carlo method.

(Supplementary Note 8)

An information processing method by a calculation processing apparatus, the method comprising:

estimating one of event and factor by giving model information the other, and generating association information, the model information representing relevance between an event that occurs on a target and the factor that occurs before the event, the association information associating first event information that represents the event obtained as the estimation result with first factor information that represents the given factor or associating second event information that represents the given event with second factor information that represents the factor obtained as the estimation result; and

specifying the factor of third event information representing an event occurred on the target based on the model information by using the third event information and, at least, one of the first event information and the second event information included in the association information.

(Supplementary Note 9)

A recording medium storing an information processing program causing a computer to achieve:

a generation function for estimating one of event and factor by giving model information the other, and generating association information, the model information representing relevance between an event that occurs on a target and the factor that occurs before the event, the association information associating first event information that represents the event obtained as the estimation result with first factor information that represents the given factor or associating second event information that represents the given event with second factor information that represents the factor obtained as the estimation result; and

a specification function for specifying the factor of third event information representing an event occurred on the target based on the model information by using the third event information and, at least, one of the first event information and the second event information included in the association information.

(Supplementary Note 10)

The recording medium storing the information processing program according to supplementary note 9, the program further comprising:

the specification function selects a piece of association information among the association information in accordance with a selection condition of selecting the piece of association information and specifies the factor of the third event information by using the first event information or the second event information included in the selected piece of association information, and the third event information.

(Supplementary Note 11)

The information processing apparatus according to supplementary note 2, wherein

the selection criteria is a condition that a range of the first event information or the second event information in case of a range of the first factor information or the second factor information is equal to or more than a predetermined value.

(Supplementary Note 12)

The information processing apparatus according to any one of supplementary notes 1 to 7 and 11, wherein the generation means estimates one of the event and the factor from the other based on the event represented by using a probability and the factor represented by using a probability.

(Supplementary Note 13)

The information processing apparatus according to any one of supplementary notes 1 to 7 and 11 to 12, wherein interval of timing at which the generation means generates the association information is longer than interval of timing at which the specification means specifies the factor.

This application is based upon and claims the benefit of priority from Japanese patent application No. 2017-002453, filed on Jan. 11, 2017, the disclosure of which is incorporated herein in its entirety.

### REFERENCE SIGNS LIST

101 Information processing apparatus
102 risk estimation unit
103 factor update unit
104 factor estimation unit
105 factor information storage unit
106 definite data storage unit
107 event information storage unit
108 model information storage unit
109 selection update unit
110 association information storage unit
111 observation data storage unit
112 criteria information storage unit
113 updated factor information storage unit
151 value
152 area
153 area
154 association information
155 area
201 information processing apparatus
202 risk estimation unit
203 factor update unit
204 factor estimation unit
205 farming data storage unit
206 definite data storage unit
207 growth information storage unit
208 crop model information storage unit
209 selection update unit
210 association information storage unit
211 observation data storage unit
212 criteria information storage unit
213 updated farming data storage unit
301 information processing apparatus
302 generation unit
303 specification unit
20 calculation processing apparatus
21 CPU
22 memory
23 disk
24 non-transitory recording medium
25 input apparatus
26 output apparatus
27 communication IF

What is claimed is:

1. An information processing apparatus comprising:
a memory storing instructions; and
a processor connected to the memory and configured to executes the instructions to:
estimate one of event and factor by giving model information the other, and generate association information, the model information representing relevance between an event that occurs on a target and the factor that occurs before the event, the association information associating first event information that represents the event obtained as the estimation result with first factor information that represents the given factor or associating second event information that represents the given event with second factor information that represents the factor obtained as the estimation result; and
specify the factor of third event information representing an event occurred on the target based on the model information by using the third event information and, at least, one of the first event information and the second event information included in the association information.

2. The information processing apparatus according to claim 1, wherein
the processor configured to select a piece of association information among the association information in accordance with a selection condition of selecting the piece of association information and specifies the factor of the third event information by using the first event information or the second event information included in the selected piece of association information, and the third event information.

3. The information processing apparatus according to claim 2, wherein
the selection criteria represents a condition that a scatter degree of the first event information or the second event information is smaller than a scatter degree of the first factor information or the second factor information.

4. The information processing apparatus according to claim 1, wherein
the processor configured to calculate, as the first event information, possibility of the event occurred by the factor or calculates, as the second factor information, possibility of the factor that has occurred when the event occurs.

5. The information processing apparatus according to claim 4, wherein
the processor configured to generate a plurality of the association information, the association information associating a plurality of the first factor information with a plurality of the first event information in case of each of the first factor information or associating a plurality of the second factor information with a plurality of the second event information in case of each of the plurality of the second factor information.

6. The information processing apparatus according to claim 1, wherein
the processor configured to select one of the first factor information or the second factor information based on the association information and specifies, as the factor, a factor represented by the selected factor information.

7. The information processing apparatus according to claim 6, wherein
the processor configured to specify the factor by executing processing in accordance with sequential Bayesian filtering, data assimilation, or Markov Chain Monte Carlo method.

8. An information processing method by a calculation processing apparatus, the method comprising:
estimating one of event and factor by giving model information the other, and generating association information, the model information representing relevance between an event that occurs on a target and the factor that occurs before the event, the association information associating first event information that represents the event obtained as the estimation result with first factor information that represents the given factor or associating second event information that represents the given event with second factor information that represents the factor obtained as the estimation result; and
specifying the factor of third event information representing an event occurred on the target based on the model information by using the third event information and, at least, one of the first event information and the second event information included in the association information.

9. A non-transitory recording medium storing an information processing program causing a computer to achieve:
a generation function configured to estimate one of event and factor by giving model information the other, and generate association information, the model information representing relevance between an event that occurs on a target and the factor that occurs before the event, the association information associating first event information that represents the event obtained as the estimation result with first factor information that represents the given factor or associating second event information that represents the given event with second factor information that represents the factor obtained as the estimation result; and
a specification function configured to specify the factor of third event information representing an event occurred on the target based on the model information by using the third event information and, at least, one of the first event information and the second event information included in the association information.

10. The non-transitory recording medium storing the information processing program according to claim 9, the program further comprising:
the specification function selects a piece of association information among the association information in accordance with a selection condition of selecting the piece of association information and specifies the factor of the third event information by using the first event information or the second event information included in the selected piece of association information, and the third event information.

11. The information processing apparatus according to claim 2, wherein
the selection criteria is a condition that a range of the first event information or the second event information in case of a range of the first factor information or the second factor information is equal to or more than a predetermined value.

12. The information processing apparatus according to claim 1, wherein
the processor configured to estimate one of the event and the factor from the other based on the event represented by using a probability and the factor represented by using a probability.

13. The information processing apparatus according to claim 1, wherein
interval of timing at which the processor generates the association information is longer than interval of timing at which the processor specifies the factor.
